(19) United States
(12) Patent Application Publication
(10) Pub. No.: US 2012/0060035 A1
(43) Pub. Date: Mar. 8, 2012

(54) Secure and Verifiable Data Handling

(75) Inventors: Gaurav D. Kalmady, Kirkland, WA (US); Umesh Madan, Bellevue, WA (US); Sean Nolan, Bellevue, WA (US); Ali Emami, Seattle, WA (US)

(73) Assignee: MICROSOFT CORPORATION, Redmond, WA (US)

(21) Appl. No.: 12/877,679

(22) Filed: Sep. 8, 2010

(51) Int. Cl. H04L 9/32

(52) U.S. Cl. 713/176

(57) ABSTRACT

The described implementations relate to secure and verifiable data handling. One implementation can receive a request to add information from a drop-off site to a user account. The request can include a location element and a security element. This implementation can also obtain encrypted units of the referenced data from the drop-off site based upon the location element. This implementation can associate the information with the user account and store the security element.

### BACKGROUND

Traditional secure data handling techniques are ill equipped to handle large amounts of data, such as may be encountered with images, video, etc. In these scenarios, the ability to secure the data depends upon possession of all of the data at a single instance. With large amounts of data, the induced latency of such a requirement makes data handling impractical.

### SUMMARY

The described implementations relate to secure and verifiable data handling. One implementation can negotiate parameters for uploading patient information to a drop-off site. The patient information can include a referencing element and associated referenced data that is not included in the referencing element. The implementation can unitize the referenced data based upon at least one of the negotiated parameters. It can also encrypt individual units of the referenced data with a security element, such as a password. This implementation can further upload the encoded individual units to the drop-off site effective that only an entity possessing the negotiated parameters and the security element can access the encoded individual units.

Another implementation can receive a request to add information from a drop-off site to a user account. The request can include a location element and a security element. This implementation can also obtain encrypted units of the referenced data from the drop-off site based upon the location element. This implementation can associate the information with the user account and store the security element.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-2 show examples of scenarios for implementing secure and verifiable data handling concepts in accordance with some implementations of the present concepts.

FIGS. 3-4 collectively illustrate an example of information that can be securely and verifiably handled in accordance with some implementations of the present concepts.

FIGS. 5-7 illustrate examples of flowcharts of secure and verifiable data handling methods in accordance with some implementations of the present concepts.

FIG. 8 is an example of a system upon which secure and verifiable data handling can be implemented in accordance with some implementations of the present concepts.

### DETAILED DESCRIPTION

### Overview

This patent relates to information handling in a secure and verifiable manner that is suitable for handling very large amounts of data. The information can be secured in a manner that allows it to be safely stored by an un-trusted third party. Further implementations can allow an entity to upload information into a system without trusting any aspect of the system, such as other entities and/or networks. A user, such as an owner of the information can authorize a system entity to obtain the information and associate the information with the user or an account of the user. Lacking such, the uploaded information can remain secure from unauthorized access.

Among other configurations, the present concepts can be applied to a scenario where the information is manifest as an element, such as a document that references data that is not contained in the element. (Hereinafter, the element is referred to as the “referencing element”, while the data is referred to as the “referenced data”). The referenced data can be unitized and the security of each unit can be verified. Thus, the present implementations lend themselves to scenarios where the referenced data entails very large amounts of data, such as may be encountered in images, such as medical images or video, among others.

In some implementations, the referenced data can be unitized. For example, a blob of data can be divided into multiple units, such as chunks. Other implementations may operate without dividing the blob by selecting a chunk size that is equal to the blob size, among other solutions. Thus, in the latter example the blob can be treated as a unit of referenced data. Unitized referenced data can be hashed and/or encrypted. For instance, each unit of referenced data can be individually hashed. An overall data hash can be created from the hashes of the units such that an entirety of the referenced data need not be possessed to secure the referenced data. Unitization allows fewer resources to be utilized in handling the referenced data without compromising data security.

Considered from one perspective, the present concepts can be thought of as offering unitized secure and verifiable data handling (USVDH). The discussion below explains how USVDH can address uploading, storing, and retrieving referenced data that may be manifest in multiple units, such as blobs (or BLOBs). (The term is a common abbreviation in the field for Binary Large Object). Individual referencing elements can range from small to large in size, measured in bytes. The discussion also addresses how a reader of the referenced data can validate its integrity and source using hashes and digital signatures. The discussion further addresses potential problems associated with transmitting large data over unreliable networks and uploading data in an out-of-order or parallel fashion for better throughput.

In some implementations, an entity in possession of a user's information (e.g., referencing element and referenced data) can request a reference or citation to a data container for the user at a drop-off site or holding pen. Metadata relating to the referencing element and the referenced data can be stored in (or referenced to) the data container. The entity can unitize the referenced data and encrypt the units utilizing a security element, such as a password or encryption key that is known to the user. The encrypted units can be uploaded to the data container at the drop-off site in the form of an information package. The user can give permission, such as by providing the security element and container or location information, to another entity to fetch the encrypted units from the data container. Without the user's security element and container information, the encrypted units remain inaccessible and secure at the drop-off site (and/or secure from an administrator of the drop-off site). In an instance where the user authorizes another entity to access the contents of the data container, the another entity can handle the encrypted units on a unit-by-unit basis rather than having to possess and handle all of the referenced data at one time.

### First Example Scenario

The discussion above broadly introduces USVDH concepts. To aid the reader in understanding these concepts, scenario 100 provides a tangible example to which the concepts can be applied. Example scenario 100 involves information in the form of patient medical records. Patient medical records can be quite large and, by law, require high security. This example is provided for purposes of explanation, and the present concepts can be applied to other scenarios outside of medical records, such as legal records, financial records, government classified data, etc.

Scenario 100 includes information 102 in the form of a patient's records that include radiologist's findings and scans upon which the findings are based. For purposes of explanation this example includes five computers 104(1)-104(5). Computer 104(1) is the radiologist's computer, computer 104(2) is the patient's general practitioner's computer, computer 104(3) is the patient's computer, computer 104(4) is a USVDH service provider's computer and computer 104(5) is a third party computer. For purposes of discussion, computers 104(1)-104(3) can be thought of as client computers. Computers 104(1)-104(4) can include USVDH modules 106(1)-106(4), respectively. Assume further that the USVDH service provider's computer 104(4) via its USVDH module 106(4) in cooperation with the client computers can offer a secure and verifiable patient record storage system. Briefly, one feature that can be offered with this system is the ability to guarantee security and integrity of patient information even when the information is stored at an untrusted third party location, such as computer 104(5). For instance, computer 104(5) may be representative of third party cloud computing resources.

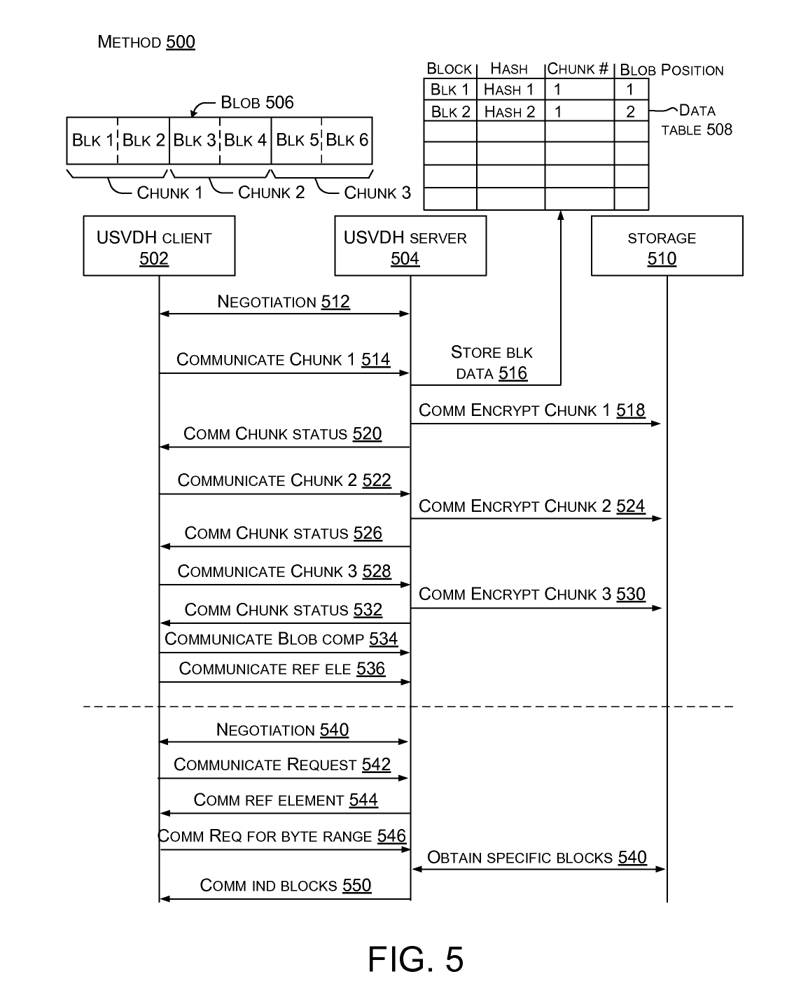

Assume for purposes of explanation that the information 102 was generated when the patient visited the radiologist. The radiologist took images, such as CT scans and/or MRIs. Images tend to include relatively large amounts of data. The radiologist evaluated the images and generated a report of his/her findings that references the images. In this example, the radiologist's report is an example of a referencing element and the images are examples of referenced data. The USVDH module 106(1) on the radiologist's computer 104(1) can facilitate communicating the information to the USVDH service provider's computer 104(4). For instance, the USVDH module 106(1) can negotiate with USVDH module 106(4) regarding conditions for communicating information 102 to the USVDH service provider's computer 104(4). Briefly, such conditions can relate to identifying a unique ID of the patient or patient account and/or communication channels over which the information is communicated and/or parameters for hashing, among others. Examples of these conditions are described in more detail below and also relative to FIG. 5.

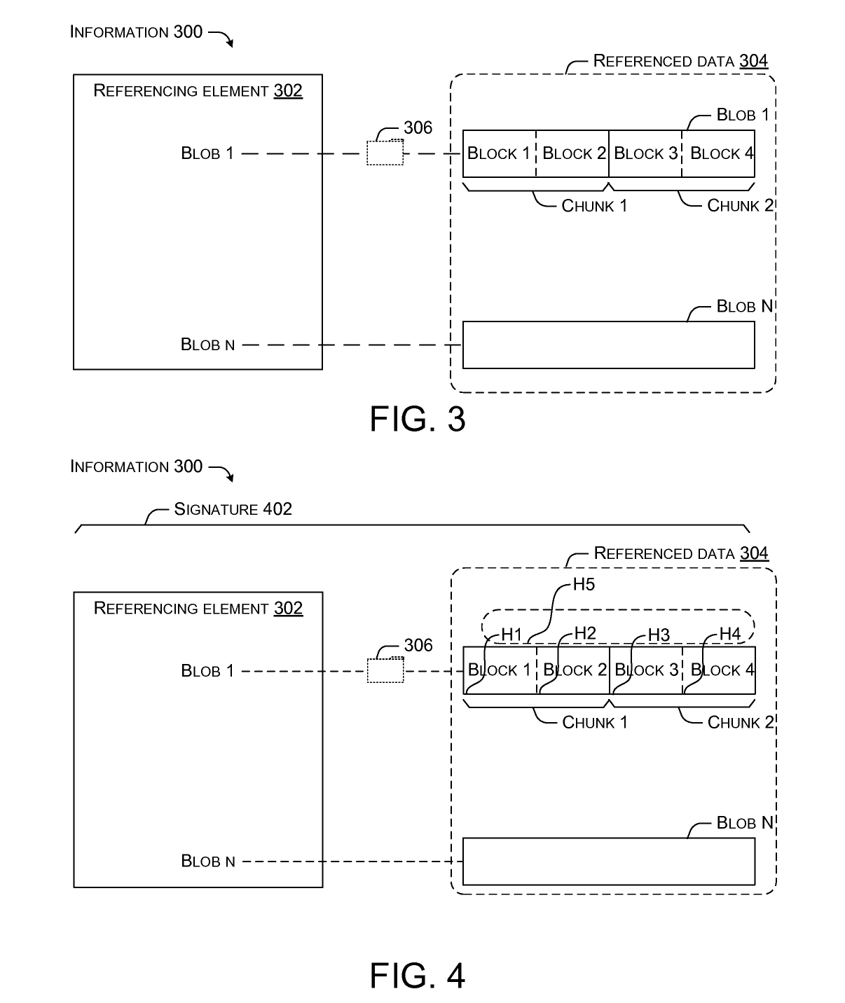

The present implementations can handle situations where information 102 is a relatively small amount of data. These implementations can also handle situations that involve very large amounts of data, such as represented by the described patient images which are often multiple gigabytes each. Toward this end, the USVDH module 106(1) on the radiologist's computer 104(1) can unitize information 102 into one or more units 108(1)-108(N) (“N” is used to indicate that any number of units could be employed). The units can be sent to USVDH service provider's computer 104(4) as indicated by arrow 110. In some implementations, the USVDH module 106(1) can hash each unit individually prior to sending the unit to the USVDH service provider's computer 104(4). Examples of units are described in more detail below relative to FIGS. 3-4.

In some implementations, the individual units can be sent by the radiologist's computer in an unencrypted form. In other implementations, USVDH module 106(1) can encrypt individual units. In one such example, the radiologist's office may have a standard practice of unitizing information 102. The unitized information can be associated with the user, such as by a unique ID. The individual units can be encrypted with a security element, such as an encryption key associated with the user. The individual units can then be uploaded to the USVDH service provider's computer 104(4). Encrypting the units prior to the units being transmitted from the radiologist's computer means that no part of the system (e.g., the network, the USVDH service provider's computer, cloud resource's computer, etc.) beyond the radiologist's computer need be trusted. Thus, the patient's information remains secure and inaccessible as “black units” without the user's encryption key.

In some implementations, unitizing the data can allow the data to be sent over multiple channels, from multiple different computers at the radiologist's office, and/or without regard to ordering of the units. This aspect will be discussed in more detail below relative to FIGS. 5-8. Further, the present implementations can handle the individual units and the overall information in a secure and verifiable manner. For instance, the radiologist's office can send units of data to the USVDH service provider's computer 104(4). In some implementations, the USVDH service provider's computer 104(4) can create an overall hash of the patient information from the hashes of the individual units.

Recall that the individual units may already be encrypted when received from the radiologist's computer 104(1) or they may be received unencrypted. In either case, (i.e., whether the individual units are encrypted or not) the USVDH service provider's computer 104(4) can encrypt the individual units. By encrypting individual units, the USVDH service provider's computer does not need to possess all of the information at one time and can instead send secure units to third party computer 104(5) as indicated by arrow 112. Thus, the USVDH service provider's computer can handle individual units as they are received rather than having to acquire all of the information 102 before processing. (This configuration can alternatively or additionally be advantageous at a subsequent read time (e.g., ‘get’ request) as will be discussed below). Further, in the above described configuration, each unit can be hashed and encrypted so that the USVDH service provider's computer does not need to rely on the security of third party computer 104(5).

Once the USVDH service provider's computer 104(4) receives all of the patient information, it can create an overall hash from the individual unit hashes. In some configurations the overall hash is not created until the unique ID or password is obtained and the data decrypted. These configurations do not require the USVDH service provider's computer to be in possession of all of the patient information to create the overall hash. Instead, the overall hash can be created from the hashes of the individual units. The USVDH concepts also allow the radiologist an opportunity to digitally sign the patient information that was uploaded to the USVDH service provider's computer.

Assume for purposes of explanation that, at a subsequent time, the patient's general practitioner wants to access some of the patient information. The general practitioner can access some or all of the patient information via the USVDH service provider's computer 104(4) by supplying a unique ID and encryption key for the information. In other implementations once the user supplies the unique ID the general practitioner can access the data without the encryption key. Further, assume that the general practitioner only wants to see the radiologist's findings and one of the images.

The USVDH service provider's computer's USVDH module 106(4) can retrieve individual units 108(1)-108(N) that include the desired portions of the information from the third party cloud resources computer 104(5) as indicated by arrow 114. The USVDH service provider's computer 104(4) can then send the relevant units of the patient information to the general practitioner's computer 104(2) as indicated by arrow 116. This implementation can further allow the general practitioner to verify the integrity of the supplied patient information and the digital signature of the radiologist. Similarly, the patient can access any part, or all, of the patient information utilizing patient computer 104(3) as indicated by arrow 118. In each case, the USVDH service provider's computer 104(4) can obtain individual units of the patient information, decrypt the units and forward the units to the patient or general practitioner without being in possession of all of the patient information. In an instance where the units have been encrypted twice, the USVDH service provider's computer can first decrypt utilizing its own encryption key and then decrypt again using the user's decryption key.

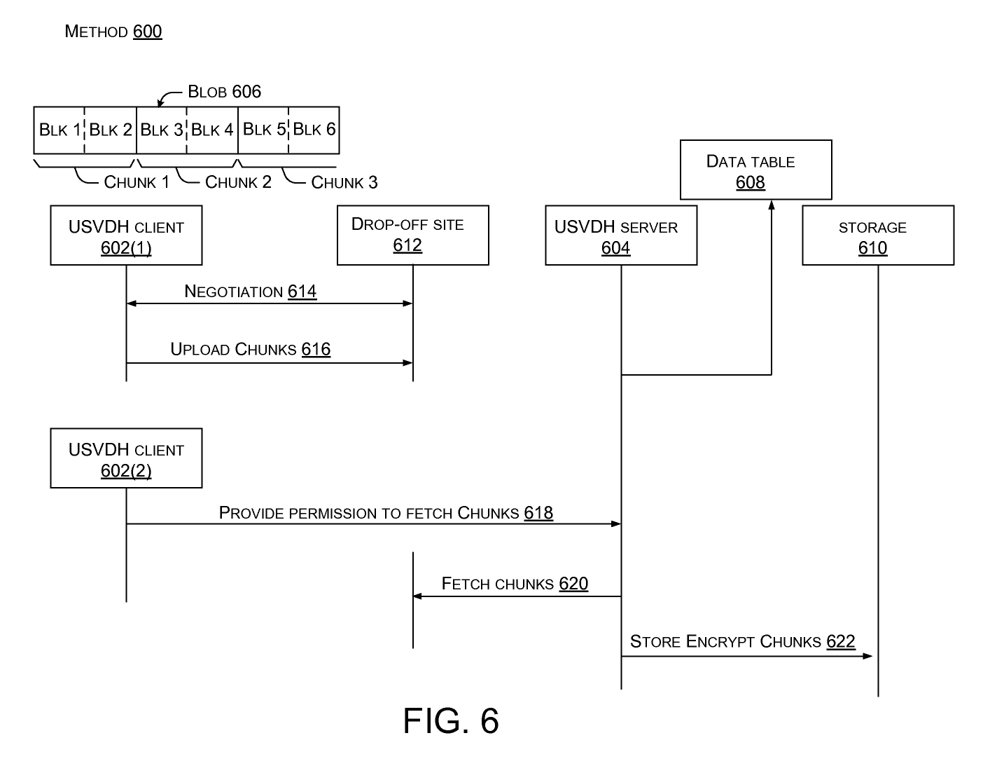

Note also, that the patient's information need not be static. For instance, either the general practitioner or the patient can alter the patient information by adding/removing data and can also be given the option of re-signing after the changes. Note further still, that while for sake of brevity each of computers 104(1)-104(5) are discussed in the singular sense, any of these computers could be manifest as multiple machines or computers. For instance, USVDH service provider's computer 104(4) could be distributed, such as in a cloud computing context in a similar fashion to cloud resources computer 104(5). This aspect is discussed in more detail below relative to FIG. 6.

In summary, the USVDH concepts can offer a reliable protocol for uploading data to a server and storing the data in a persistent data store, such as a cloud storage system, a database, or a file system. As the data is uploaded to the server, metadata can be computed that is used to generate a small unique digest (i.e., hash) of the data which can be used to guarantee the integrity of the data. In other implementations, the data is uploaded in an encrypted form and further processing is delayed until decryption is performed. In either case, the data can be grouped into collections or units which can be referenced by referencing elements or referencing elements within an electronic health record or other logical container of data, and the referencing elements and the referenced collection of data can be read and the integrity of this data verified by a reader of the referencing elements. The USVDH concepts can further allow selectively creating collections of data items (e.g., referenced data) that are uploaded to a server and keeping a reference to this collection through referencing elements which can be stored in an electronic health record. The USVDH concepts can additionally offer the ability for the data item collection to be modified by adding or removing items. The USVDH concepts also offer the ability to specify the sections of referenced data to retrieve, since the referenced data may be large and often only a section of the referenced data is needed.

In some implementations, the USVDH concepts can offer an ability to generate a digest of the referenced data as it is uploaded to the server. The digests can be used by readers of the referenced data to ensure that the referenced data has not been tampered with or modified in any way by a party with access to the referenced data, by the storage system or any intermediate storage system, or by unintended changes in the referenced data such as network, hardware, or software errors. Stated another way, the present implementation can offer the ability to generate a digest of the referencing element and the referenced data without needing the referencing element and the referenced data in their entirety at any given time.

The above features can allow the referenced data, such as blob data to be stored in a system that is external from the one which the client interfaces. Briefly, the ability to safely store the referenced data in such a manner can be supported by encrypting the referenced data on a unit by unit basis. For example, the clients can be thought of as computers 104(1)-104(3) which interact with USVDH service provider's computer 104(4), but do not interact with cloud resources computer 104(5). In a particular example the client can interface with USVDH service provider's computer 104(4) manifested as HealthVault-brand health records system offered by Microsoft® Corp. HealthVault can then interface with an external store, (e.g., cloud resources computer 104(5)) such as Azure™, SQL storage™, a storage appliance (i.e. EMC™, IBM™, Dell™, etc.). In other implementations, the encrypting can be accomplished first upon a client device associated with the user, such as a clinic where the user undergoes imaging. This first encrypting can ensure that the units of the information are secured when transmitted from the client device (e.g., the user need not trust any part of the system beyond the local client computer). Further encryption can be performed by the USVDH service provider to provide additional security so that the USVDH service provider can store the units outside of its control without compromising the security of the units of patient information. This second encryption may utilize a more robust encryption technique than that commonly employed in client settings. These concepts are described in more detail below by way of example.

### Second Example Scenario

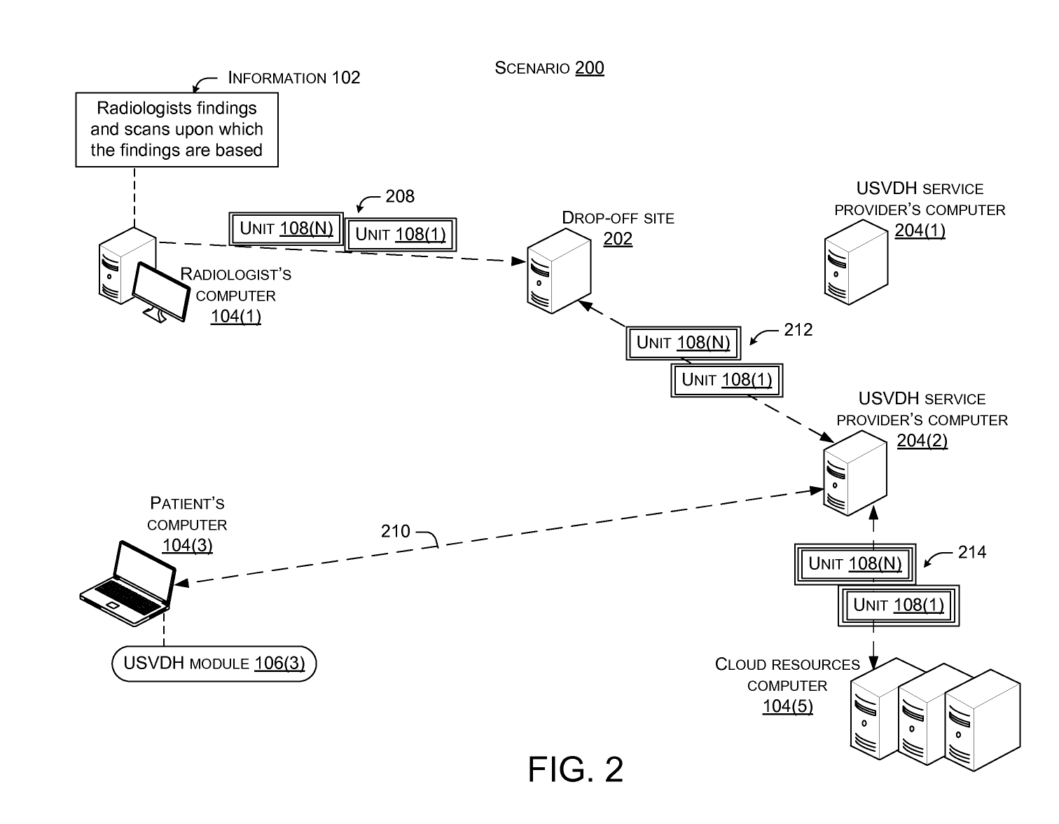

FIG. 2 shows another scenario 200 to which the concepts can be applied. Similar to the above example, scenario 200 involves the same patient visit to the radiologist (represented by radiologist's computer 104(1)), the patient information 102, as well as the patient's computer 104(3) and the cloud resources computer 104(5). This example also includes a drop-off computer or drop-off site 202 and two USVDH service provider's computers 204(1) and 204(2). The two USVDH service providers' computers can represent two entities offering competing patient information data management plans or platforms. The patient may or may not have an account with either one of the two entities to manage his/her patient information at the time the patient visits the radiologist. (Of course, while two USVDH service providers' computers are illustrated, any number of service providers could be involved).

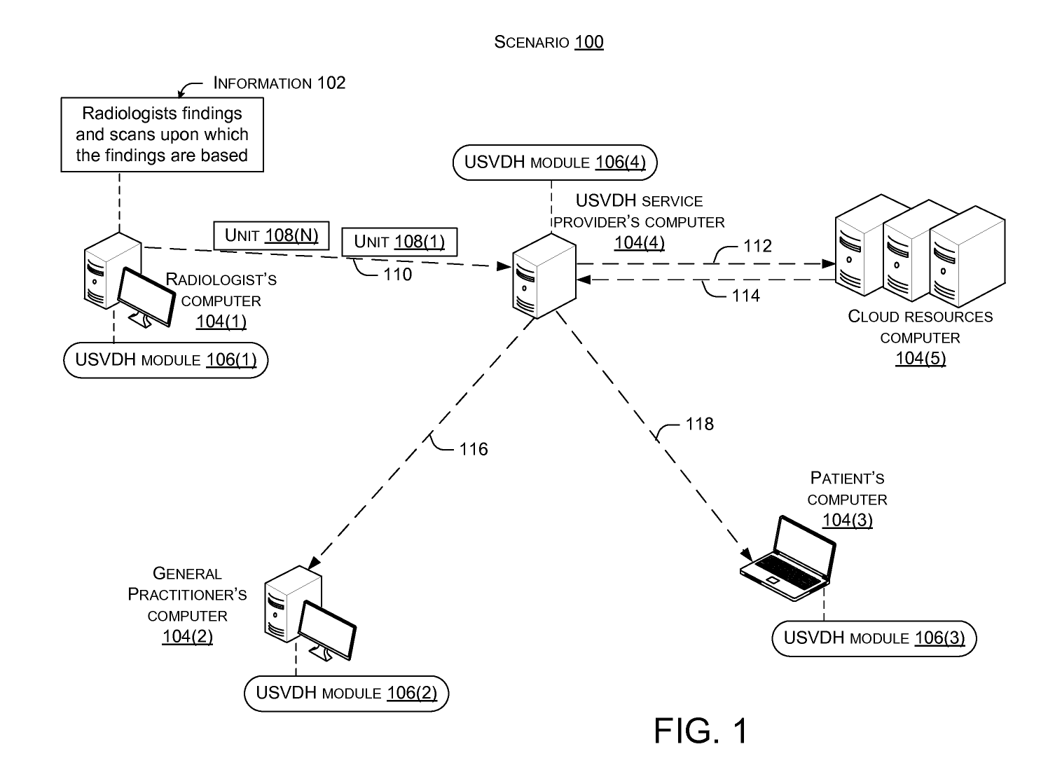

As with the example of FIG. 1, the radiologist can unitize the patient information. In this case, individual units 108(1)-108(N) can be encrypted and sent to drop-off site 202. In one implementation, the radiologist can obtain a password from the patient, associate the units 108(1)-108(N) with the patient's unique ID and encrypt the units with the password. Note that the password and/or other unique data can be used as the encryption key or can be used to generate the encryption key. The radiologist can upload the encrypted units 108(1)-108(N) (encryption indicated as a box around the units) to the drop-off site 202 as indicated at 208. The configuration can allow the radiologist's computer 104(1) to upload the encrypted units 108(1)-108(N) to the drop-off site 202 without regard to whether the patient has created an account with one of the USVDH service providers and if so which one.

In some implementations the radiologist's computer 104(1) can obtain a reference or citation to a data container at the drop-off site 202. The data container can hold the encrypted units and any metadata related to the encrypted units at the drop-off site.

If the patient has an account with an individual USVDH (or subsequently sets up an account), the patient can send the unique ID and the password to the respective USVDH service provider's computer 204(1) or 204(2). Assume, for purposes of explanation, that the patient has an existing account or that the user subsequently sets up an account with USVDH service provider's computer 204(2). The patient can send the patient's unique ID and the password to the USVDH service provider's computer 204(2) as indicated at 210. In a case where a data container is employed to contain the patient information at the drop-off site, the patient can send a location (e.g., the citation) of the data container to the USVDH service provider's computer 204(2).

The USVDH service provider's computer 204(2) can use the information from the patient (e.g., the patient's unique ID, etc.) to obtain the encrypted units 108(1)-108(N) from the drop-off site 202 as indicated at 212. The USVDH service provider's computer 204(2) can encrypt (e.g., double-encrypt) the retrieved encrypted units utilizing its own encryption key. The USVDH service provider's computer 204(2) can associate the retrieved encrypted units with the patient (e.g., with the patient's account or with the citation in the case where the user does not have an account with the USVDH service provider). The USVDH service provider's computer 204(2) can store the patient's password and/or calculate hashes upon the data. (The password can be used at a subsequent time to decrypt the encryption of the units 108(1)-108(N)).

The USVDH service provider's computer 204(2) can encrypt individual encrypted units 108(1)-108(N) again using an encryption technique and encryption key selected by the USVDH service provider's computer (double encryption indicated as a two boxes around the units). The USVDH service provider's computer can then store the now double-encrypted units 108(1)-108(N), such as at cloud resources computer 104(5) as indicated at 214. While not specifically shown the patient information can be retrieved in a manner similar to that described above relative to FIG. 1.

In an alternative scenario, the user may not establish an account with any of the USVDH service providers. Without authorization from the patient, the encrypted units deposited at the drop-off site at 208 remain inaccessible. The deposited units can remain at the drop-off site indefinitely or may be destroyed after a predetermined period of time. In either case, the security of the patient's information can be maintained.

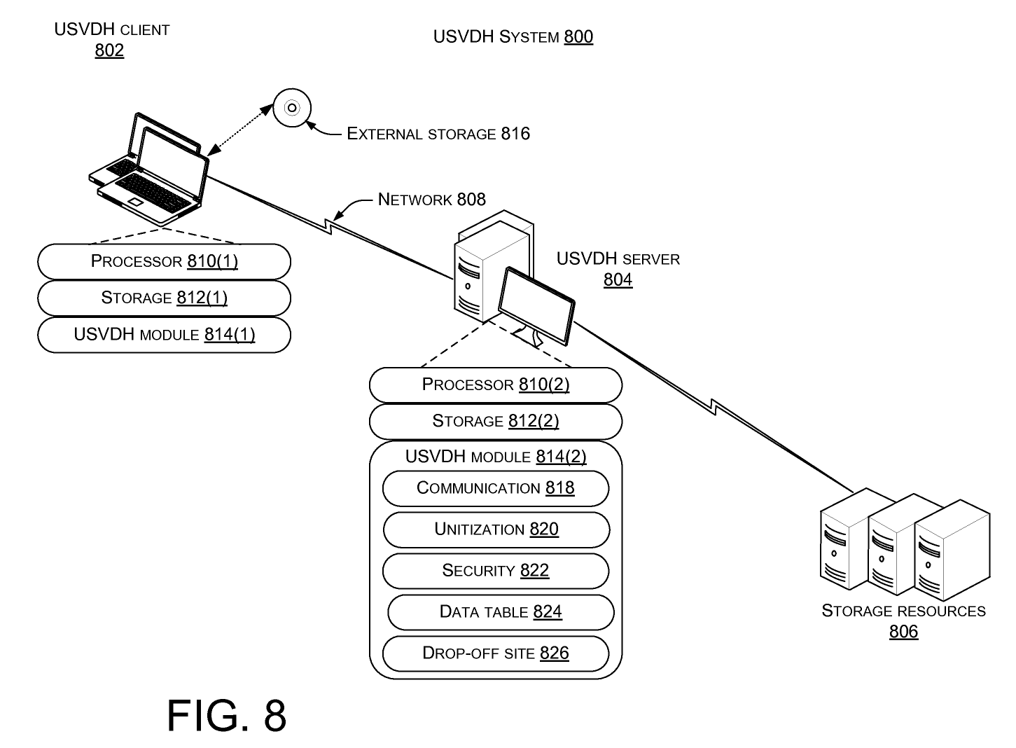

To summarize, scenario 200 describes a drop-off/pickup mechanism that can allow the patient information to be stored by the drop-off site 202. In some configurations, the drop-off/pickup mechanism can function as a holding pen for patient information including unitized encrypted referenced data. In one configuration, the drop-off site can be associated with a particular USVDH service provider. (Such an example is illustrated below relative to FIG. 8).

In the presently illustrated configuration, the drop-off site can be accessed by any USVDH service provider selected by the user as long as the selected USVDH service provider complies with pick-up guidelines established by the drop-off site. Thus, the patient can select a selected USVDH service provider and thereby establish a trust relationship with the selected USVDH service provider. The patient can then pick up the information from the drop-off site and add it to his or her account. Until the pick-up action takes place, no system entity should be able to view or interpret the patient information in the drop-off site. For this reason multiple referencing elements and/or referenced data can be encrypted in an encrypted blob(s) and placed in the drop-off site waiting for the patient to present authorization in the form a password or similar security element. Once this authorization is received, the patient information can then be decrypted and moved to the patient's account at an individual USDVH service provider. Also note that in another scenario the patient information could still exist at the drop-off site when a ‘get’ request is received for some or all of the information. In such a case, as long as the ‘get’ request includes the citation to the data container at the drop-off site, the patient information can be retrieved from the drop-off site responsive to the get request rather than from the patient's account.

Another implementation can be summarized as follows. First, the radiologist's machine gets from the patient a password, and uses the password to encrypt each chunk. Each patient password encrypted chunk is sent to the USVDH server. The USVDH server stores all this data in a temporary holding pen, since it has no identifying information to get a reference to the patient account and thus to the patient data container. Since the cloud may not be secure, the USVDH server can choose to encrypt the encrypted chunks a second time. The USVDH server does not need to decrypt those chunks, just encrypt the encrypted data again. This is done with a key that USVDH server chooses per blob. The data now remains in the temporary holding pen until the user (e.g., patient) picks it up. At a subsequent time in the future, the patient may decide to pick up his or her data within the USVDH server (or platform). The patient now reveals the password to USVDH server.

Although the patient has an account and a data container for his/her data within USVDH server, the data within the package is not transferred immediately into the data container. Instead, linkages are created between data items in the holding pen and the patient's container. Whenever the patient requests to read the data, the linkages are followed to get to the data in the holding pen. The data continues to be doubly encrypted, except now the USVDH server has both the encryption keys rather than just the one it chose and used to encrypt the data the second time. So the USVDH platform can decrypt the chunks; first removing its own encryption and then since it has the patient password, it can remove the inner patient password based encryption. Thus, the USVDH platform can return raw data to the patient.

It is worth noting that the data requester need not be a patient, it can be any other application or another doctor's office and so on. As long as the patient has accepted the package by supplying the password, both layers of encryption can be decrypted to get the raw data. Thus, the data can be instantly available to all readers the moment the password is revealed by the patient to the USVDH server.

The USVDH server can also have the secondary responsibility of verifying signatures and hashes of the data when the data is uploaded. In some implementations, this responsibility cannot be fulfilled until the USVDH server decrypts the data entirely and computes hashes on the raw data. To fulfill this need and also to reduce the work of double decryption on every read, the USVDH server can, once it has the password, at its own leisure in the background, start double decrypting and transferring the package data into the patient's own container, which it now knows about.

The USVDH server can compute hashes as the data is being transferred to the patient's own container and can verify the signature once the transfer is complete. In some implementations the data is not committed and not available to be read outside the USVDH server until the signature is determined to be valid by the USVDH server. In another implementation, the data is made available and a signature state (described below relative to FIG. 6) is used to indicate the validity of the signature.

### Information Example

FIGS. 3-4 collectively show an example of information 300 that can be managed utilizing the present unified secure verifiable data handling concepts. The information could be patient records, financial records, etc. In this case, information 300 is manifest as a referencing element 302 that is associated with referenced data 304 that is external to the referencing element. In this example, the referenced data is in the form of blob 1 and blob N. It is worth noting that this configuration allows different blobs to be stored in different storage systems. For instance, blob 1 could be stored in Azure, while blob N is stored in SQL storage. Also, the referenced data 304 can be organized via one or more optional intervening organizational structures, such as a folder 306 (shown in ghost), but this aspect is not discussed further herein.

As mentioned above, an individual blob can be almost any size from small to very large. Very large blobs, such as video or medical images, may create latency issues when managed utilizing traditional techniques. The present implementations can allow individual blobs to be unitized into more readily manageable portions. In this example, blob 1 is unitized into two chunks designated as chunk 1 and chunk 2. Further, individual chunks can be unitized into blocks. For instance, chunk 1 is unitized into block 1 and block 2 and chunk 2 is unitized into block 3 and block 4.

The blocks and/or chunks are more readily handled in a secure and verifiable manner than their respective blobs. Toward this end, a small unique digest, such as a hash of an individual unit, can be generated to (attempt to) guarantee the integrity of the data or content of the individual unit. In this example, as indicated in FIG. 2, a hash can be created for each block. For instance, hash H1 is generated for block 1, hash H2 for block 2, hash H3 for block 3, and hash H4 for block 4. A hash can be created for the blob from its respective unit hashes without possessing all of the blob data at one time. For instance, hash H5 can be generated from hashes 1-4 rather than from the blob data itself. Further still, an entity, such as a user like a healthcare provider or the patient, can sign referenced data 304 and/or the referencing element 302 and a part or the entirety of the referenced data 304 using the above mentioned hashes. Some implementations allow a single signature over the referencing element and the referenced data. In one such example signature 402 indicates the source and/or validation of the signature indicates integrity of referencing element 302 and referenced data 304. The above example is but one implementation of the present unitized secure verifiable data handling concepts. Other implementations should become apparent from the description below.

As used herein, the term blob can be used to refer to the referencing elements and/or referenced data described above that will be uploaded to the server. This refers to data that is treated as a series of bytes by a system. The bytes may have some logical structure such as a JPEG image or an MPEG movie. However, a system can interpret the data to discover this structure, for example by reading the first n bytes and auto-detecting its format against a set of known patterns. Alternatively, the system may know the structure of the bytes through means external to the data itself, for instance through a parameter or metadata indicating the format of the blob. When a system treats data as a blob, the data may be referred to as ‘unstructured,’ meaning the system treats the data as a simple series of bytes without any understanding of the structure of those bytes. Thus, any data that can be interpreted as a series of bytes can be considered a blob and thus is valid data that can be used with the present implementations.

A blob is a series of bytes and can be thought of as a series of chunks, where each chunk is a series of bytes. For instance a blob with 100 bytes will have 10 chunks if the chunk size is 10 bytes. Thus, a blob can be thought of as a series of bytes, or as a series of chunks. The concept of chunk allows discussion of a blob in terms of its constituent chunks. The concept of a chunk exists once a numerical chunk size is defined for a particular context.

For a particular context, a number of bytes can be defined as a chunk. The term full chunk may be used throughout to refer to a chunk whose length is exactly equal to chunk size. In contrast, a partial chunk is a chunk of data that does not have a length exactly equal to the chunk size defined for the particular context. Also, the length of the partial chunk should be between 1 and (chunk size-1). The length of a partial chunk cannot be 0 because this implies the partial chunk does not exist, also the partial chunk cannot have length equal to chunk size since this implies that it is a full chunk. If the chunk size is defined as 1 in the context, then it is not possible to have a partial chunk.

Just as a blob can be partitioned into a series of chunks, a chunk can be partitioned into a series of blocks once a numerical block size is defined for a particular context. In some implementations, the chunk size is defined to be a multiple of the block size (e.g., the blocks are integer factors of the chunk). This can facilitate restartability in case of a network error during blob upload. Other implementations that do not utilize a chunk size that is a multiple of block size can also offer restartability, however, the process may be significantly more resource intensive. These features are described in more detail below relative to FIG. 5.

A blob hash algorithm can be used to produce a cryptographic hash of a blob. Two examples of blob hash algorithms are described in this document. The first is the ‘Block hash algorithm’ and the second is the ‘Chained Hash algorithm’ (described below).

A blob hash is a cryptographic hash of the blob. This hash is accompanied by a hash algorithm and the parameters for producing the hash from the data. A hash block size can be thought of as the block size parameter to use with the blob hash algorithm.

Block Hash Algorithm Example

Consider a blob for which the blob hash is to be produced using the block hash method. The inputs to the algorithm are the base hash algorithm and block size. The base hash algorithm is any cryptographic hash function that takes as input a series of bytes and produces a digest or hash (for instance SHA-256, SHA-1, etc.). The blob is partitioned into n blocks based on the input block size. Each block is numbered in sequential byte order of the blob starting with block number 0.

A hash can be calculated for each block using the base hash algorithm. The process can be repeated for each block. The block hashes can be organized in any fashion to be hashed to produce a blob hash. In one such case, the block hashes are organized in sequential order and the base hash algorithm is utilized to create the blob hash.

As a specific example assume h0, h1, h2 represent the block hashes for a blob with three blocks b0, b1, b2. Thus, h0=hash (b0), h1=hash (b1), h2=hash (b2). Then the blob hash h is computed as h=hash (h0|h1|h2), where the | is the function to append the block hash bytes.

Chained Hash Algorithm Example

Consider a blob for which the blob hash is to be produced using the chained hash method. The inputs to the algorithm are the base hash algorithm and the block size. The base hash algorithm is any cryptographic hash function that takes as input a series of bytes and produces a digest or hash (for instance SHA-256, SHA-1, etc.). The blob is partitioned into n blocks based on the input block size. Each block is numbered in sequential byte order of the blob starting with block number 0.

A hash h0 is calculated using an array of bytes with all bytes having the value ‘0’ and length equal to a hash result, and the first block of the blob. h0 is used as input for the next block of data. Specifically, h0 is appended to the next block and the hash of this joinder is calculated to produce h1. h1 is appended to the subsequent block and the hash calculated, producing h2. The process can continue until the hash of the last block is calculated which represents the final blob hash.

As a specific example, assume a blob with blocks b0, b1, b2. First, h0 is computed as hash (0|b0), where 0 is an array of bytes with the values being zero with length equal to the size of a hash result. Next, compute h1=hash (h0|b1). Finally, h2=hash (h1|b2). The blob hash here is h2.

### First Method Example

FIG. 5 shows a USVDH method example 500. This method relates to accomplishing a ‘put’ of information and a ‘get’ of the information. The ‘put’ can be thought of as an upload protocol description that is consistent with some implementations. The ‘get’ can be thought of as a download protocol description for retrieving information that is consistent with some implementations. For purposes of explanation, consider this method example as an interaction between a USVDH client 502 that wishes to upload information in the form of a set of blobs to a USVDH server 504, and associate those blobs with a referencing element that may describe the blobs. The USVDH client further wishes to persist the referencing element and blobs such that both can be retrieved through a different interaction, such as the ‘get’. For sake of brevity, only a single blob 506 of the set of blobs is illustrated. The method can also be applied to additional blobs of the set. The server can access a data table 508 and storage 510. It is also noted that the method is described relative to the USVDH client 502 and the USVDH server 504 to provide a context to the reader. The method is not limited to execution by these components and/or modules and can be implemented in other context, by other components, modules and/or systems.

Initially, at 512, a negotiation can occur between USVDH client 502 and the USVDH server 504. In one case, the negotiation can involve the USVDH client 502 making a request to the USVDH server 504 indicating the client's desire to upload blob 506. In some implementations, there may be some mechanisms in place to identify USVDH clients making this request, or to restrict the USVDH clients that can successfully indicate their desire to upload a blob. In the request, the USVDH client can specify the parameter values it supports or wants to use for uploading the blob. Alternatively or additionally, the USVDH service provider might specify some of the parameters. Examples of these parameters can include a location identifier parameter, a token, a maximum blob size, a chunk size, a blob hash algorithm, and a hash block size, among others.

The location identifier parameter can identify where the data should be sent. For example, the location identifier parameter may include a reference or citation to a data container where the data can be stored. In one case, the citation can be a URL of the data container. The token can uniquely identify the blob being uploaded. The maximum blob size can be thought of as the maximum size the USVDH server 504 will accept from the USVDH client 502 for the whole blob that is being uploaded. The chunk size, blob hash algorithm, and hash block size are discussed above relative to FIGS. 3-4.

The blob hash algorithm can be used for calculating the blob hash. The hash block size can be used as input to the blob hash algorithm to calculate the blob hash. In some cases, the USVDH server 504 may provide a range for an individual parameter and let the USVDH client 502 pick a parameter value from the range. The USVDH client also can have the option of letting the USVDH server decide the parameter values it will use for the parameters. The interface is flexible in supporting any number of new parameters going forward.

The above mentioned negotiation process between the USVDH client 502 and USVDH server 504 to agree upon the parameters can be advantageous when compared to other solutions. For example the ability to have adjustable parameters potentially offers flexibility over fixed configurations. For example, the USVDH server can respond with a set of parameters based on some conditions or events. For instance, the location identifier can be different for each blob request, or for each USVDH client, based on some knowledge of server load or location of the client as examples. This means each blob can have a different set of blob upload parameters. Another potential advantage of this is in terms of software servicing. Since USVDH clients can be coded to dynamically interpret the protocol parameters, the method can be much more flexible and can prevent or reduce the need to update client code in many cases; for instance, if a chunk size or block size needs to change.

Once the negotiation is complete, the USVDH client 502 can communicate a chunk of data to the USVDH server 504. In the illustrated case, blob 506 is divided into chunk 1, chunk 2 and chunk 3. In one case, the USVDH client can construct a request that contains a chunk of data from the blob and sends this chunk to the USVDH server. In the present example, the USVDH client communicates chunk 1 at 514. The USVDH client does not send the next chunk (i.e., chunk 2) until a receipt is received from the USVDH server that first chunk has been received and processed. This can be termed a serial approach. Further, in this example, the chunks are communicated in order, (i.e., first chunk, second chunk, then third chunk, but such need not be the case). Other implementations can employ a parallel approach where multiple chunks are communicated simultaneously. This aspect will be discussed in more detail below.

In some implementations, the request from the USVDH client 502 includes some information that identifies what data within the blob 506 is being uploaded in the request. For example, this can be a byte range within the blob specified by a starting byte offset and an ending byte offset within the blob data that is being transmitted to the USVDH server 504 in the request.

In some particular implementations, the USVDH client 502 transmits full chunks of the blob data to the USVDH server 504 in a single request, except for the last chunk of the blob which may be a partial chunk. A full chunk has length equal to ‘chunk size’ as defined by the negotiated upload parameters which are described above relative to FIGS. 3-4.

In these particular implementations, the USVDH client 502 can transmit a single chunk or multiple chunks of blob data in a single request, as long as they are all full chunks with the exception of the last chunk of the blob.

This requirement, employed by particular implementations, to transmit only full chunks of blob data to the USVDH server 504 applies only to the blob data being transmitted and does not apply to any preamble data, header data, message envelope data, and/or protocol data, among others, that is transmitted by the USVDH client 502 to the USVDH server in making the request to the server. Other USVDH implementations may be configured differently from the above described example and thus are not bound to any ‘requirements’ associated with written transmission data sizes.

Recall, as mentioned above relative to the discussion of FIG. 1, that the client may send the units of data encrypted or unencrypted. In this example, the units of data that are sent are chunks. Accordingly, the chunks can be sent from USVDH client 502 to USVDH server 504 either encrypted or unencrypted. Whether the USVDH client encrypts the chunks can depend on various factors, such as whether a secure channel has been obtained between the USVDH server and the USVDH client, terms negotiated with the user, etc. Encrypting the chunks can decrease or eliminate the need for the USVDH client to trust downstream components and services. An encryption key used by the USVDH client to encrypt the chunks may be sent to the USVDH server at a different time and/or over a different channel than the chunk itself. Further, the encryption key may be sent from a different USVDH client than the USVDH client that sends the chunks.

The USVDH server 504 can receive the first chunk of data as indicated at 514. The USVDH server can calculate intermediate hashes as output by the intermediate steps in the blob hash algorithm (block hash or chained hash) for each block within the transmitted chunks. Thus, the algorithm's output itself can be the blob hash.

At 516, the method can store chunk and/or block data in the data table 508. For instance, the block data can relate to the block number, the hash of the block, and the overall position of the block in the blob, among others. While not expressly shown due to space constraints on the drawing, this step can be repeated for the other chunks received at 522 and 528. For reasons that should become apparent below, the block hashes can be thought of as ‘intermediate hashes’.

The chunks transmitted to the USVDH server 504 are partitioned into blocks based on the block size from the blob upload parameters. Since an integer number of chunks were transmitted to the USVDH server and the chunk size is a multiple of the block size, the USVDH server can be guaranteed to have received an integer number of blocks.

In the case where the block hash algorithm is used, the USVDH server 504 can compute a hash for each block received. These intermediate hashes are stored in the data table 508 so they can be read at a later point in time.

In the case where the chain hash algorithm is used, the current intermediate hash is appended to the first block of the data received and the chain hash algorithm applied. If it is the first block of the blob then the 0 array as described in the algorithm is used and the chain hash algorithm started. Once all blocks in the data received are processed and the resulting hash is determined (i.e., the blob hash), this resultant blob hash is stored, such as in data table 508, so as to be able to retrieve the resultant blob hash at a later time.

At 518, chunk 1 can be encrypted and the encrypted chunk can be communicated to storage 510. Any type of encryption technique can be employed. In an instance where the chunk was encrypted by the USVDH client prior the chunk being sent to the USVDH server, then the USVDH server can be thought of as encrypting an encrypted chunk. In some cases, the USVDH server may employ a more robust encryption technique than is employed by the USVDH client, but such need not be the case. Whether the USVDH server received an encrypted or unencrypted chunk, the chunk is now encrypted. The encryption key employed by the USVDH client and the encryption key employed by the USVDH server can be stored in data table 508. Since the chunk is encrypted, the storage need not be trusted. Accordingly, storage 510 may be associated with the USVDH server 504 or may be associated with a third party, such as a cloud storage system.

Stated another way, the USVDH server 504 can store the blob data to a store such as a cloud storage system, a database, or a file system as examples. The USVDH server can also store some metadata, such as in data table 508, identifying what section of the blob was received, based on the info specified by the USVDH client. The metadata can be read at a later time. In cases where the metadata and the data itself are stored in different storage systems that cannot be transacted, then the possibility can arise where the data is stored but an error occurs storing the metadata. Often times the data can be large and can be expensive to store. Thus, in this case the system can ensure the data that was stored is rolled back or cleaned up by a different interaction.

Once the metadata is successfully stored, the USVDH server 504 can respond to the USVDH client 502 indicating that individual chunk(s) were successfully written. This is indicated as communicate chunk status 520. For its part, the USVDH client received the status or acknowledgement from the USVDH server that the chunks were successfully stored by the server, or the USVDH client may receive an error code from the USVDH server, or may time out waiting for a response.

In the illustrated implementation, the USVDH client 502 waits to get a response acknowledgement of success from the USVDH server 504, then the client proceeds to send the next chunks of the blob data. In this case, chunk 2 is communicated at 522. However the USVDH client need not wait for a response from the USVDH server 504 server to begin a chunk transmission for a different range of the blob. Viewed from one perspective this can be described as the ability for USVDH clients to upload data in parallel. The USVDH client has this option if the blob hash algorithm is the block hash algorithm, but does not have this option if the algorithm is the chained hash algorithm. In the case of the chained hash algorithm, the chunks are sent in ascending sequential order and parallelization is not possible.

Additionally, the USVDH client 502 has the option to send chunks out-of-order. This means that the chunks do not have to be sent in sequential order if the blob hash algorithm is the block hash algorithm. This option does not exist if the chained hash method is used. Further, the chunks can be sent in any order in implementations where the chunks are encrypted prior to sending.

The USVDH client 502 cannot be sure that the data of a given chunk was stored until the response acknowledgement for a given chunk request has returned a successful acknowledgement. If the USVDH client 502 received an error from the USVDH server 504 while waiting for the response, then the USVDH client can determine if the error is caused by an action that can be corrected by the client or if the error was a USVDH server specific error. This determination can be made by knowledge of error codes and other information utilized by the USVDH server. If possible the USVDH client can take action to correct the issue and continue to process or upload blob data. In the case of a USVDH server or network error, the USVDH client can retry the request by sending it to the server again. Likewise, if the USVDH client times out waiting for a response from the USVDH server, then the USVDH client can attempt the request again.

For ease of explanation, assume that the chunks are received and handled successfully by the USVDH server 504. Recall that chunk 2 was communicated at 522. The USVDH server encrypted chunk 2 and communicated chunk 2 to storage at 524. The chunk 2 status is communicated to the USVDH client at 526. Also, note that, while not shown, data relating to chunk 2 is added to data table 508. Similarly, chunk 3 is communicated at 528. Chunk 3 is encrypted and then communicated to storage at 530. The status of chunk 3 is communicated back to the USVDH client at 532.

At some point the USVDH client 502 can mark the blob as being complete and no more data can be added to the blob. For instance when the last chunk is uploaded to the USVDH server 504 at 528, the USVDH client can include in this request some information indicating it is done uploading data for this blob. Alternatively, the USVDH client can send a request with no blob data but that indicates the blob is complete. For instance, a blob complete communication is indicated at 534.

When the USVDH server 504 receives this blob complete communication 534, the USVDH server can first process any chunks in the request as described above. Subsequently, the USVDH server can read the intermediate hashes from data table 508, and can compute the blob hash as defined by the blob hash algorithm. Note that for data encrypted at the client side the data can be decrypted with the encryption key prior to further hashing. For block hashing, the USVDH server can sequentially append the block hashes together and compute an overall blob hash from the block hashes. For chain hashing, the current intermediate hash is the blob hash. The blob hash is stored with the blob metadata. Any intermediate hashes and temporary blob metadata can be cleaned up at this point. In some cases, cleaning up can mean deleting some or all of the intermediate hashes and/or temporary blob metadata.

These steps (i.e. steps 512-534) can be repeated for each blob the USVDH client wants to upload. Once all blobs are uploaded, the USVDH client can create a referencing element that references the blobs. The referencing element can describe some or all of the blobs, or it can simply contain the references to the blobs. The USVDH client can make a request to the USVDH server to commit the referencing element. In this example the request is indicated as communicate referencing element at 536.

The referencing element can subsequently be retrieved and both the referencing element and any retrieved units of the blobs can be read. In the request the USVDH client 502 makes a request that uniquely references individual blobs or blob units. For instance, the USVDH client can use a token from the blob upload parameters to identify individual blobs. In another instance, the blob ID is contained in the referencing element, and the USVDH client first requests the referencing element to get the IDs for the blobs.

In addition to the above steps, the USVDH client 502 has the option to apply a digital signature to the referencing element to ensure any readers of the data can guarantee its integrity and its source. This can be accomplished using standard digital signature techniques. If the referencing element is to be signed, the client includes the blob hashes for all the blobs that are referenced by the referencing element in the data to be signed. Since the client received the blob hash algorithm, block size and any other relevant parameters for calculating the blob hash as part of the blob upload parameters, the USVDH client is able to calculate the blob hash in a similar manner as that described above for the USVDH server 504.

In some implementations, when the USVDH client communicates the referencing element to the USVDH server at 536, the server will ensure all the blobs referenced in the referencing element have at least one chunk of data, either full or partial, that is defined for a contiguous range, and that have been marked completed as described above. If the referencing element has a digital signature applied, the USVDH server will ensure all the blobs that are referenced in the referencing element are included in the data that is signed. In another configuration, the USVDH server can also validate the digital signature of the referencing element using standard techniques. The USVDH server can ensure the blob hashes that are in the data that is signed are equal to the blob hashes that were calculated by USVDH server. This configuration can prevent a bad digital signature in the system.

The USVDH server 504 can store the referencing element including the references to the blobs. In the illustrated configuration, the USVDH server can store the referencing element in the data table 508. (Note, that data table 508 can include different and/or additional information than is illustrated). In another implementation, the USVDH server can persist a new reference to the blobs as opposed to the one that was used to identify the blob for the request to commit the referencing element. This aspect can be accomplished via data table 508 or with another data table (not shown for sake of brevity).

In some cases, the USVDH client 502 can communicate multiple referencing elements at 536. In this case, the semantics described above can be repeated for each referencing element. It is worth noting that data table 508 may be updated and/or deleted at this point. For instance, some information in the data table may no longer be needed, other information can be added, or a new data table can be created that includes information that is useful for a ‘get’ described below. For instance, blob ID, blob hash, block size, chunk size, encryption key employed by USVDH client and/or encryption key employed by USVDH server, etc. may be useful in the ‘get’ processes described below.

The above discussion relative to steps 512-536 relate to protocols, methods and systems for uploading or putting information into storage. The following discussion relates to the interactions for reading referencing elements and verifying their integrity and source. The reading USVDH client may be different from the USVDH client that uploaded the data. Specifically, the concept of unitizing the referenced data, such as into blocks, can reduce resource usage, such as bandwidth and memory that the USVDH server can use for other tasks. Some implementations can create a blob hash without needing the whole blob in memory. For instance, using block hashes can allow the block hashes to be read instead of the whole blob of data for validating the digital signature and blob hashes. Further, block hashes can be utilized to verify portions of blobs rather than having to verify the entire blob. Further still, blob hashes can be verified by the USVDH server 504 and/or USVDH client 502 without the need to have the whole blob data in memory.

At 540, negotiation can occur between the USVDH client 502 and the USVDH server 504. The negotiation can be similar to that described above relative to a ‘put.’ For instance, USVDH server 504 can interrogate the USVDH client 502 to ensure that the client has permission to access the information. The negotiation can also involve establishing a channel, etc. as discussed above. The USVDH client 502 can communicate a request to the USVDH server 504 to retrieve the referencing element at 542. In another implementation the USVDH client can fetch the referencing element which contains the parameters for getting the blobs. The USVDH client can query for the referencing element against a set of known parameters such as unique IDs of the referencing element or types of the referenced data. The USVDH server can communicate the referencing element to the USVDH client at 544.

Once the USVDH client 502 has the referencing element, the client will also have references to the blobs that can be used to read each blob. The USVDH server 504 can allow the client to read sections of the blob, say for example through byte ranges. Often, the USVDH client desires to read only a section of the blob. In such a scenario, the USVDH client can communicate a request for a byte range from the USVDH server 504 at 546. The USVDH server 504 can reference data table 508 and identify individual chunks that include the desired section of bytes.

In some implementations, having the chunk size is sufficient to satisfy a byte range query. For instance if chunk size is 10, and the requested range is 12-26, then chunk 2 can be read to get bytes 12-20 and chunk 3 read to get bytes 21-26. The USVDH server can obtain those specific chunks from storage 510 as indicated at 548. The USVDH server can decrypt the chunks.

The USVDH server can then communicate the chunks to the USVDH client 502 at 550. It is noteworthy that the USVDH server does not have to communicate blocks/chunks only. For instance, since the USVDH client can request a byte range, the USVDH server can respond with data that spans multiple chunks and is not delineated by chunk boundaries. It is further noteworthy that the USVDH server does not need to obtain the entire blob from storage to accomplish this process. Further, if the desired information spans multiple chunks, individual chunks can be retrieved, validated, and forwarded to the USVDH client without waiting for all of the multiple chunks to be obtained from storage 510.

The retrieved chunks can be validated in that when an encrypted chunk is retrieved from the external store and read, decryption can be performed. Successful decryption is an indicator that the chunk has not been modified by the storage 510 (or other party). Failed decryption is an indicator that the chunk may have been modified. If the chunks were encrypted both by the USVDH client and the USVDH server, the USVDH server can first decrypt the encryption that it made and then decrypt the USVDH client's encryption. This decryption process can be accomplished with encryption metadata that can be stored by the USVDH server 504 in data table 508. Examples of such encryption metadata can include encryption keys and initialization vector, among others.

The above mentioned configuration can reduce resource usage, such as bandwidth and memory that the USVDH server 504 can use for other tasks. Further, this configuration can decrease the latency experienced by the USVDH client 502 in awaiting the data when compared to retrieving the entire blob.

Further, in an instance where the referencing element is signed, the signature over the referencing element can be validated by the USVDH server 504 (and/or by the requesting USVDH client) using standard digital signature validation techniques. If a certificate is available with the signature, then the USVDH client 502 may validate the certificate against a policy, for instance ‘is the signer of the data a trusted entity?’. Additionally, the individual blobs can be read from the USVDH server and the blob hashes independently calculated by the reading USVDH client. The USVDH server and/or USVDH client can compare the calculated blob hash for each blob against the hashes found in the referencing element for that blob. This gives the reading USVDH client the assurance that the blob data was not modified intentionally or unintentionally, since it was created by the original creating or ‘putting’ USVDH client.

In summary, the described implementations offer the ability to encrypt blobs on a per-chunk basis for storage in an external blob store. These implementations also offer the ability to retrieve arbitrary chunks of the blob with decryption on-the-fly. These implementations can also offer the ability to re-send a failed chunk of data while maintaining all the other functionality described herein. Networks tend to be unreliable and the likelihood of a network error while uploading large data is high, thus a solution to the problem of re-sending data in case of a failed response or timeout from the server can be advantageous.

Another described feature is the ability to upload data in an out-of-order fashion (i.e. in non-sequential byte order), and in a parallel fashion while maintaining the other functionality described herein. Parallel uploading allows improved throughput and allows USVDH techniques to adapt the performance of the data upload depending on network characteristics. For instance as network bandwidth increases over time, the USVDH techniques can utilize more parallelization in the data uploads to take advantage of the improved bandwidth.

Another described feature relates to mechanisms to track the committing of data to the storage system. In cases where the nature of the storage system does not allow transacting with the storage system where the referencing elements are stored, this tracking can be utilized to ensure cleanup of data in the external store.

### Second Method Example

FIG. 6 shows another example method 600 for accomplishing secure and verifiable data storage. Method 600 is explained relative to USVDH clients 602(1) and 602(2), USVDH server 604, blob 606, data table 608 and storage 610. These components are similar to those described above relative to FIG. 5 and are not re-introduced here for sake of brevity. FIG. 6 adds a drop-off computer or drop-off site 612 which is similar to drop-off site 202 introduced above relative to FIG. 2. Note once again, that while for purposes of explanation, particular components are discussed relative to method 600, implementation of the method or similar methods is not tied to particular components.

Method 600 can allow a USVDH client 602(1) (hereinafter, “sending USVDH client”) to securely upload information into a system without trusting any system components and/or without a knowledge of whether a pre-established relationship exists between an owner of the information, such as USVDH client 602(2) and a system component, such as USVDH server 604. Recall that the information, in some instances, can include a referencing element(s) and referenced data in the form of the blob(s).

Initially, at 614, a negotiation can occur between USVDH client 602(1) and drop-off site 612. In some cases, the negotiation can entail sending USVDH client 602(1) ascertaining guidelines for uploading information to drop-off site 612. For instance, the guidelines may specify parameters, such as size of units of a referenced data blob that can be uploaded, a reference URL, and an encryption algorithm. In some instances, where the information is to be signed by the USVDH sending client, the parameters can relate to hash algorithm and block size. In some cases, the negotiation can involve establishing a data container at the drop-off site for the information. In other instances, the negotiation can involve assigning a citation or reference to a specific data container at the drop-off site for the uploading. In some cases, the data container can be chosen from a list of pre-created data containers.

In some examples, USVDH server 604 may be involved in the negotiation 614. In such scenarios, drop-off site 612 can be considered as a portion of, controlled by, or associated with, the USVDH server. In one such case, the negotiation 614 can include the USVDH client 602(1) (e.g., requestor) sending a request to the USVDH server 604. The request can include the encryption algorithm to be employed by the USVDH client 602(1). The USVDH server 604 can return a pre-encryption chunk size and/or a pre-encryption block size used for calculating block hashes to be used by the USVDH client 602(1) and a blob reference URL that can be used to create a put request to upload the chunks. In such cases, for externally stored data, the USVDH server 604 can associate a temporary container in the storage with the encrypted drop-off implementation introduced above relative to FIG. 2 that includes a temporary container in the storage for the uploaded data (sometimes referred to as a ‘connect package blob’). For blobs that are locally stored, a similar process can be utilized to pick the data container for the blob data.

In an instance where the referencing element is to be signed, the USVDH sending client 602(1) can calculate the block hashes of the chunks (on the unencrypted data). The USVDH sending client can encrypt each chunk individually using the encryption key. The size of the encrypted chunk is a function of the pre-encryption chunk size and the encryption algorithm used. This is a well understood property of all standard block ciphers. For instance, if the pre-encryption chunk size is A, then for a given algorithm, the encrypted chunk size will be B.

The sending USVDH client 602(1) can create a package for use in a streaming or non-streaming scenario. The sending USVDH client 602(1) can link the negotiated reference urls to the referencing element. For each referencing element that is to be signed, the sending USVDH client 602(1) can calculate a blob hash for each blob associated with the particular referencing element based on the constituent block hashes. The blob hash can be associated with the referencing element. The sending USVDH client 602(1) can then digitally sign the referencing element and the process can be repeated for subsequent referencing elements (if any).

The sending USVDH client 602(1) can then encrypt the chunks. In one case, the sending USVDH client 602(1) can prepare to upload the referenced data by generating an encryption key for the referenced data. For instance, the encryption key can be generated from a (question, answer) pair associated with the data container. In one case, the USVDH sending client can divide the source stream into chunks of the negotiated pre-encryption chunk size.

At 616, sending USVDH client 602(1) can upload chunks to the drop-off site 612. This can be achieved over one or more communication channels, in a consecutive or non-consecutive order, and/or in a parallel or serial fashion.

Subsequently, at 618 the patient or user via USVDH client 602(2) (hereinafter, “user USVDH client”) can provide permission for USVDH server 604 to fetch the chunks from the drop-off site 612. For instance, the user either has an account with the USVDH server 604 or can establish an account. The user can issue a call to fetch the chunks and associate them with the user account. For example, the user can supply the password (e.g., security element) and the reference urls (e.g., location element) to the USVDH server 604.

At 620, USVDH server 604 can fetch the uploaded chunks from drop-off site 612 utilizing the patient supplied password (question answer pair, etc) and the blob reference. For each blob, upon receipt of the password, the metadata of the blob can be copied from the database (or other data table) where it is stored temporarily, to the database (or other data table) associated with the user's account. For instance, the blob can be uploaded to the holding pen, and some number of days later the user password may be supplied. The blob metadata can remain in the first database for the entire time.

If requested by the patient USVDH client 602(2), the USVDH server 604 could decrypt units of the information utilizing the patient supplied password (question answer pair, etc) and send requested data to the patient. Otherwise, the USVDH server can encrypt the fetched chunks (above and beyond the encryption performed by the sending USVDH client 602(1)).

At 622 the USVDH server 604 can store or commit the retrieved and encrypted chunks at storage 610 and await a subsequent retrieval or get request. This aspect is discussed relative to FIG. 5 above.

If any of the referencing elements are signed by the sending USVDH client 602(1), the USVDH server 604 can validate that the digital signatures are valid before placing the referencing elements and units of referenced data in the user's account. The USVDH server 604 can validate the signatures by calculating the same blob hash for each blob referenced by the signed referencing element and ensure the calculated blob hashes match the blob hashes specified by the sending USVDH client 602(1). In some configurations, in order for USVDH server 604 to calculate the blob hashes, the USVDH server reads all blob data that is referenced by signed referencing elements. This is potentially a large amount of data and can take a long time. For instance each blob could be >1 GB and stored externally. USVDH server 604 has known the password for the package only for a short time (since provided by USVDH client 602(2)) and would likely not have been able to perform this operation earlier.

Some implementations handle this situation by the USVDH server 604 performing background processing to validate the signatures. The USVDH server can read the blob data (whether stored internally or externally) and can calculate the blob hashes and verify they are correct. From this, the USVDH server can validate the digital signatures of the referencing elements to be stored in the user's account. In this case, the USVDH server does not store the referencing elements and unitized referenced data in the user's account until all signed referencing elements have their digital signature validated. Once this is done, the referencing elements and unitized referenced data are stored in the user's account. The USVDH server can send the user a notification (i.e. e-mail or other means) that there is new data available in their account. If the signatures are not valid, the data is not stored in the user's account. Before signature validation, the user is unable to access the data from the data container.

An alternative implementation can handle this situation by defining a signature state on all referencing elements. The signature states could be: “Not Validated”, “Valid”, and “Invalid”. To enable the user to access the data before the USVDH server had validated the digital signatures, the USVDH server could mark the referencing element with a signature state of “Not Validated”. This would provide an indication to a reader of this data that the USVDH server had not yet validated the digital signature. In the background, the USVDH server could validate the signature (by reading the blob data, calculating and validating the blob hashes, and validating the digital signature). Once this process is completed the USVDH server could change the signature state to either “Valid” or “Invalid” depending on whether the signature was valid.

A potential advantage of the latter approach over the former approach is the data is immediately available in the user's account and can be read by the user and other applications immediately after it is picked up. A potential disadvantage of the latter approach over the former approach, is it can require all applications to know about the signature state and it can also leave open the possibility of having data in a record with an “invalid” digital signature. With the former approach, this is not possible since the signature is validated before the data is put in the user's record. Additionally, with the first approach readers are not required to know about signature states as they do not exist.

Some ‘get’ requests may specify particular byte ranges of the referenced data. A mapping between a length of a raw chunk of bytes and the encrypted range created by a block cipher with a known key and initial vector (IV) results in a block size that is a known function independent of the bytes themselves. Briefly, in some implementations, the process of cryptographic encoding of a set of bytes is as follows. First, the set of bytes is divided into a set of frames, say 32-128 bytes long. Next, a function is applied that takes as input a key and an initial vector which is a frame sized byte set that contains something arbitrary but known to the encryptor/decryptor. The function will work on the first frame of the bytes and produce an encoded representation. This encoded representation becomes the IV to encode the second frame of bytes. So every frame is encoded based on a global key and the result of encoding the previous frame. This process relies on having the first frame decoded before the last frame can be decoded. As a result decoding cannot be performed in the middle. The present concepts can address this shortcoming by chopping the byte set into chunks. Each chunk can take the place of the entire byte set. Stated another way, the process of encoding can be restated for every chunk. Thus, every chunk thus gets its own IV. In some cases, this IV is computed from the blob id and the chunk number and is deterministic. Hence every chunk can be decoded independently of every other chunk. Thus, the last frame depending on first frame is no longer happening and no longer an issue. Consequently, at least some of the present implementations can freely allow reads to begin from the middle of the byte set.

In a specific encryption example a Rijndael algorithm is used with a block size of 256 and encryption key size of 256, the encrypted byte count=(floor(raw byte count/32)+1)*32. A whole range of raw byte counts could produce an encrypted chunk of a certain size. For example in the Rijndael case above, all chunks of sizes from 0 bytes to 31 bytes produce a 32 byte chunk. All chunks from 32 to 63 bytes produce a 64 byte chunk, and so on.

In the configuration discussed above relative to FIG. 1, the USVDH server dictates the size of the raw chunk and thus there is a single raw chunk size corresponding to the encrypted byte size. Thus, based upon the above description, consider an example with a raw chunk size of say 15 bytes. Further, assume that when encrypted, the 15 bytes correspond to the third chunk. In such a case the USVDH server fetches encrypted byte range 64-95 which corresponds to the raw byte range 45-59. Thus, the USVDH server knows encrypted ranges that correspond to raw ranges.

However, in the case where the USVDH client encrypted the data with a user password, the USVDH server fetches a double encrypted byte range from the store. While there exists a single possibility for the size of the chunk obtained after decrypting the platform encryption, a range of possibilities exist for the chunk size after removing the password encryption. This makes it potentially difficult, given only the bytes in a chunk itself to determine the corresponding raw byte range. This issue can be addressed based upon the raw chunk size in bytes as suggested to the client via the put call. If the client follows the suggestion, then a single raw chunk size can correspond to an answer encrypted chunk. That way given any answer encrypted chunk the range of bytes it contains can immediately be determined. Since the bytes received by the platform from the USVDH client are encrypted, whether the USVDH client followed the raw chunk size specification or not, cannot be verified then. Some implementations can include a feature that allows the USVDH clients to fail if the blob chunk size is not followed. This could entail the platform decrypting a random chunk in the blob (not the last) and ensuring that the decrypted bytes correspond to a full chunk of a size prescribed by the ‘put’ request. Although the failure may be somewhat late, it can still provide data integrity at the referencing element level in the platform.

Another implementation can be explained as follows. First, every raw chunk of data is of a fixed size (except the tail end or last one). Thus, for a chunk size of 15 bytes, bytes 0-14 are the first chunk, bytes 15-29 are the second chunk, and so on. Consider for example a blob whose size is 50 bytes, chunk size being 15. This blob would have 4 chunks, 0-14, 15-29, 30-44, 44-50 (incomplete last one).

In this particular implementation, the encryption algorithm increases the size of the chunk by a predictable amount. The algorithm to compute this size is dependent on the encryption algorithm used. However, since the encryption algorithm is pre-negotiated and agreed upon before the data item is created in the holding pen, the information in question is always derivable.

For purposes of explanation, consider an encryption algorithm that converts the above mentioned 15 byte chunk to a 32 byte chunk post encryption in accordance with the presently described implementation. All 15 byte chunks will become 32 byte chunks. After chunk upload, the fact that bytes 0-14 will be found in the byte range 0-32 will be true. Also, the bytes 15-29 similarly will be in the second encrypted chunk, i.e. the encrypted range from 32-63. Thus, given any raw chunk range, it can be algorithmically converted to the encrypted chunk range.

One noteworthy aspect is that when encrypted, chunks get larger, but they don't mix. Chunk 1, for example, used to be from 15-29. After encryption, it becomes the byte range 32-63. But it does not mix with the bytes of what used to be chunk 0 or chunk 2. This is useful relative to a query that asked the question ‘where are the bytes 45-59’ (i.e., which encrypted chunk(s) need to be decrypted to get to these raw bytes). This implementation can easily determine that for a known raw chunk size of 15, bytes 45-59 correspond to the chunk number 3 (the 4th chunk since the counting starts from 0). Since is also known that each chunk grows, this implementation finds the chunk number 3 after encryption. The 15 byte chunk grew to a 32 byte one after encryption. Thus, it is known that chunk number 3 post encryption will be in the bytes 32*3 to 32*4-1, i.e. in the encrypted range 96-127. Thus, this implementation knows where to look within the encrypted range to get to the raw range.

In another scenario that asked about a raw range that spanned chunks, this implementation can divide it into multiple questions. For instance, the question of ‘which chunks to decrypt to get to bytes from 15-55’ becomes ‘which chunks to decrypt to get to 15-29, 30-45 and 45-55’. For a known chunk size, these are the chunks numbering 1, 2, and 3. These numbers can then be translated into the corresponding encrypted byte range as shown above and get to the encrypted range.

When asked to fetch say 5 bytes, such as 16-20 for example which is less than a full chunk, this implementation initially figures out which of the n chunks would this piece belong to. In this example, 16-20 belongs to the range 15-29 and thus the first chunk. This implementation offers a technique to get to the data, decrypt it, and send back the raw bytes 16-20 and throw the rest away.

This is true if the encrypted chunk is subsequently encrypted. This technique can consider the ‘raw range’ to be 32-63 and ask the question ‘where will the raw range 32-63 be found if it were encrypted’. Since the technique can answer the question ‘where will 15-29 be found if it were encrypted’ (the answer being 32-63) the technique can similarly answer the same question about the 32-63 range. Thus, when a byte set is chunked and encrypted n times, regardless of how many times, as long as each encryption algorithm used follows the condition that all raw bytes chunks of size “a” always get converted to encrypted chunks of the size b where b=f(a), the technique can predict where to find any raw range.

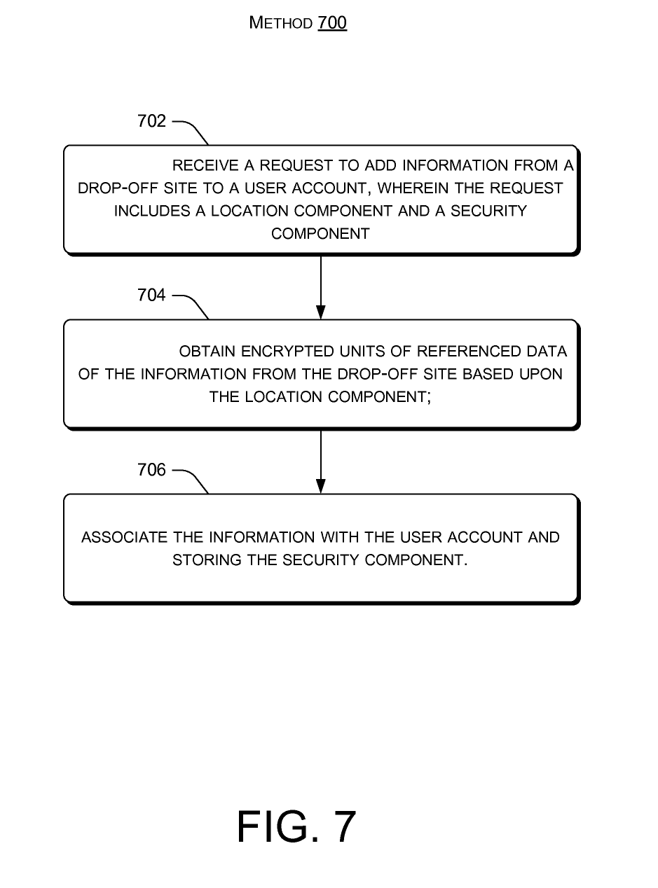

Method implementations are described in great detail above relative to FIGS. 5-6. A broad USVDH method example is described below relative to FIG. 7.

### Third Method Example

FIG. 7 illustrates a flowchart of a method or technique 700 that is consistent with at least some implementations of the present concepts.

In this case, a request to add information from a drop-off site to a user account can be received at 702. The request can include a location element and a security element. Encrypted units of the referenced data can be obtained from the drop-off site based upon the location element at 704. The information can be associated with the user account and the security element can be stored at 706.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### System Example

FIG. 8 shows an example of a USVDH system 800. Example system 800 includes one or more USVDH client computing device(s) (USVDH client) 802, one or more USVDH server computing device(s) (USVDH server) 804, and storage resources 806. The USVDH client 802, USVDH server 804, and storage resources 806 can communicate over one or more networks 808, such as, but not limited to, the Internet.

In this case, USVDH client 802 and USVDH server 804 can each include a processor 810, storage 812, and a USVDH module 814. (A suffix ‘(1)’ is utilized to indicate an occurrence of these modules on USVDH client 802 and a suffix ‘(2)’ is utilized to indicate an occurrence on the USVDH server 804). USVDH modules 814 can be implemented as software, hardware, and/or firmware.

Processor 810 can execute data in the form of computer-readable instructions to provide a functionality. Data, such as computer-readable instructions, can be stored on storage 812. The storage can include any one or more of volatile or non-volatile memory, hard drives, and/or optical storage devices (e.g., CDs, DVDs etc.), among others. The USVDH client 802 and USVDH server 804 can also be configured to receive and/or generate data in the form of computer-readable instructions from an external storage 816.

Examples of external storage 816 can include optical storage devices (e.g., CDs, DVDs etc.), hard drives, and flash storage devices (e.g., memory sticks or memory cards), among others. In some cases, USVDH module 814(1) can be installed on the USVDH client 802 during assembly or at least prior to delivery to the consumer. In other scenarios, USVDH module 814(1) can be installed by the consumer, such as a download available over network 808 and/or from external storage 816. Similarly, USVDH server 804 can be shipped with USVDH module 814(2). Alternatively, the USVDH module 814(2) can be added subsequently from network 808 or external storage 816. The USVDH modules can be manifest as freestanding applications, application parts and/or part of the computing device's operating system.

The USVDH modules 814 can achieve the functionality described above relative to FIGS. 4-5. Further detail is offered here relative to one implementation of USVDH module 814(2) on USVDH server 804. In this case, USVDH module 814(2) includes a communication component 818, a unitization component 820, a security component 822, a data table 824, and a drop-off site 826.

Communication component 818 can be configured to receive requests for a reference or citation to a data container at drop-off site 826. Such requests can be received from USVDH client 802. The data container can be configured to receive information that includes a referencing element, associated unitized encrypted referenced data, and associated metadata.

The communication component 818 can also be configured to receive a communication from an owner or user of the information in the data container. The communication can be received from USVDH client 802 or another USVDH client (not specifically shown). The communication can include a request to move the information from the data container at the drop-off site 826 into the user's account. In various implementations, the request can include a security element, such as an encryption key, password or the like used to encrypt the information in the data container. The communication component 818 can store the encryption key or password in the data table 824. The request can also include a way to identify the data container (e.g. a location element) at the drop-off site 826. For instance, the request may contain a unique ID of the data container, or a URL for the data container, among others.

The communication component 818 can be configured to receive requests for a portion of a blob associated with a referencing element in a user's account. The communication component is configured to verify that the received requests are from entities that have authorization to access the blobs. For instance, the communication component can ensure that the requesting entity has authority to access the referencing element. The communication component can employ various authentication schemes to avoid unauthorized disclosure. The unitization component 820 can be configured to unitize referenced data, such as blobs, into units. The unitization component can memorialize information about individual units in data table 8826. An example of a data table and associated functionality is described above relative to FIG. 5. Thus, if an authorized user identifies portions of the referenced data that the user is interested in, the unitization component can identify individual units that include the portions and cause the individual units to be obtained for the user rather than an entirety of the referenced data.

The security component 822 can be configured to retrieve the information from a data container at the drop-off site 826. The security component can double encrypt individual units of encrypted referenced data. Responsive to a get request, the security component can be configured to validate individual units obtained by the unitization component without accessing an entirety of the referenced data. The security component can be further configured to decrypt the one or more units without decrypting the entirety of the referenced data.

In some implementations, the USVDH server 804 and its USVDH module 814(2) may be in a secure environment that also includes storage resources 806. However, such need not be the case. The functionality offered by the USVDH module 814(2) offers the flexibility that unitized referenced data can be secured in a manner such that the environment of storage resources 806 need not be secure. Such a configuration offers many more storage opportunities for the unitized data while ensuring the security and integrity of the unitized data.

It is worth noting that in some instances, the USVDH client 802 and/or the USVDH server 804 can comprise multiple computing devices or machines, such as in a distributed environment. In such a configuration, different chunks of a blob can be sent by different USVDH client 802 machines and/or received by different USVDH server 804 machines. In at least some implementations, each chunk upload request can go to any of the USVDH server machines so load balancing can be utilized. Accordingly, no one server machine is storing the “context” for the blob in memory (e.g., the system can be referred to as “stateless”). For this reason, when a “blob complete” request is received by the USVDH server 804 any of the USVDH server machines can calculate the blob hash. This configuration is enabled, in part via the above described block hashing and storing of intermediate hashes in the data table 824.

The above configuration can allow efficient blob hash calculation for a blob. This can provide the ability to validate the integrity of the signed referencing element and the blobs it references efficiently at the time the referencing element is ‘put’ and once the user provides the unique ID or encryption key. This is an effective point to perform the validation to avoid entering data with bad digital signatures. Recall that validating the integrity of the signed referencing element can be accomplished by validating its digital signature using standard techniques. Validating the integrity of the referenced blobs can be accomplished by ensuring the hashes that are part of the signed data are equal to the calculated hashes. This configuration can allow any USVDH module to accomplish this integrity validation at any point going forward.

To summarize, this implementation offers a mechanism (in the form of USVDH module) for information to be uploaded in a secure fashion without requiring prior authorization by the owner of the information. The information to be uploaded to the drop-off site is unitized and the units are encrypted. The information remains safe and secure unless and until the user (possessing the security element and location element) requests that the information be added to his/her account. This implementation can allow a request to move the information from the drop-off site to the user account to be performed within a reasonable amount of time. Recall that the referenced data portion of the information may be very large. This implementation does not require that the referenced data be transferred all at once. Instead the referenced data can be moved on a unit-by-unit basis, encrypted and stored as available. Up to this point, the referenced data can be invisible to system components and yet be generally instantaneously available upon receipt of an authorized request.

From another perspective, the present implementations can allow a client to digitally sign the information that includes a referencing element and referenced data. The client can encrypt the signed information, such as by encrypting individual units of the information. Some of the present implementations can guarantee against non-authorized access in the holding pen (e.g., drop-off site) since the data is encrypted. The digital signature can be validated by the USVDH service provider once the user password (or equivalent) is supplied. Other parties (e.g., the general practitioner in the examples of FIGS. 1-2) can validate the signature once the password is supplied.

These implementations can allow for digital signatures to be created and validated on the data even where a holding pen is utilized to hold the unitized data.

### CONCLUSION

Although techniques, methods, devices, systems, etc., pertaining to secure and verifiable data handling are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
negotiating parameters for uploading patient information to a drop-off site, wherein the patient information comprises a referencing element and associated referenced data that is not included in the referencing element;
unitizing the referenced data based upon at least one of the negotiated parameters;
signing the referenced data and the referencing element;
encrypting individual units of the referenced data with a patient password; and,
uploading the encrypted individual units to the drop-off site effective that only an entity possessing the negotiated parameters and the patient password can access the encoded individual units.

2. The method of claim 1, wherein the at least one of the negotiated parameters relates to unit size.

3. The method of claim 1, further comprising calculating hashes of the units of the referenced data.

4. The method of claim 1, wherein the negotiating parameters includes negotiating a data container for the patient information and an address of the data container at the drop-off site.

5. The method of claim 1, further comprising providing the address of the data container to the patient.

6. At least one computer-readable storage medium having instructions stored thereon that, when executed by a computing device, cause the computing device to perform acts, comprising:
receiving a request to add information from a drop-off site to a user account, wherein the request includes a location element and a security element;
obtaining encrypted units of referenced data of the information from the drop-off site based upon the location element;
associating the information with the user account; and,
storing the security element.

7. The computer-readable storage medium of claim 6, wherein the drop-off site is controlled by an entity that controls the user account.

8. The computer-readable storage medium of claim 6, wherein the security element comprises an encryption key or a password.

9. The computer-readable storage medium of claim 6, wherein the obtaining comprises encrypting individual encrypted units utilizing a different security element.

10. The computer-readable storage medium of claim 9, further comprising storing the security element and the different security element in a data table.

11. The computer-readable storage medium of claim 6, further comprising verifying a signature of the information by calculating hashes of individual units.

12. The computer-readable storage medium of claim 11, wherein the verifying is performed upon the obtaining or upon receiving a get request for the information.

13. The computer-readable storage medium of claim 12, wherein upon receiving the get request, individual units of the information are decrypted and sent to the requestor with an indication that the signature of the information has not been verified.

14. The computer-readable storage medium of claim 13, further comprising updating the indication when the verifying of the signature is complete.

15. A system, comprising:
a communication component configured to receive a request for a citation to a data container at a drop-off site, the data container configured to receive information that includes a referencing element, associated unitized encrypted referenced data and associated metadata; and,
a security component configured to retrieve the information from the drop-off site and to further encrypt individual units of the unitized encrypted referenced data.

16. The system of claim 15, wherein the communication component is configured to receive a request from an owner of the information to associate the information with an account of the owner and wherein the owner provides an encryption key with which the unitized referenced data was encrypted.

17. The system of claim 15, wherein the system is further configured to retrieve the information from the drop-off site upon receipt of a request from an owner of the information to associate the information with an account of the owner or to retrieve the information from the drop-off site upon receipt of a get request for individual units of the information.

18. The system of claim 16, wherein the security component further stores the owner provided encryption key and an encryption key employed by the security component in a data table.

19. The system of claim 15, wherein the drop-off site is controlled by a same entity that controls the communication component and the security component.

20. The system of claim 15, manifest on a single computing device.
